(19) United States
(12) Patent Application Publication
(10) Pub. No.: US 2006/0062370 A1
(43) Pub. Date: Mar. 23, 2006

(54) Integrated call completion based upon call transfer rules

(75) Inventors: Ciprian Agapi, Lake Worth, FL (US); Can P. Boyacigiller, Annapolis, MD (US); Brent L. Davis, Deerfield Beach, FL (US); Joseph I. Herman, Ellicott City, MD (US); Vanessa V. Michelini, Boca Raton, FL (US); Michael H. Mirt, Deerfield Beach, FL (US); Melanie D. Polkosky, Boynton Beach, FL (US); Jonathan C. White, Edgewater, MD (US); Frankie S. Wilson, Boca Raton, FL (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/946,791

(22) Filed: Sep. 22, 2004

(51) Int. Cl. H04M 3/42

(52) U.S. Cl. 379/211.01

(57) ABSTRACT

A call completion system, method and apparatus for integrated directory assistance and voice activated dialing based upon call transfer rules. In accordance with the present invention, a call completion system can include a set of call transfer rules implicating one of a directory assistance interface and a voice activated dialer interface. The system further can include a call completion processor configured to select one of a directory assistance interface and a voice activated dialer interface based upon an evaluation of the call transfer rules for an incoming query.

### BACKGROUND OF THE INVENTION

1. Statement of the Technical Field

The present invention relates to directory assistance systems and voice activated directory assistance systems.

2. Description of the Related Art

Directory assistance systems provide directory lookup services to interacting end users. Directory lookup involves the location of a directory entry which corresponds to provided information. Basic directory assistance systems merely provide a result set of matching entries for a specified query. A few advanced directory assistance systems can provide “for-a-fee” post-processing operations including automatic call dialing to a phone number specified by the result set of a query. In both cases, directory assistance queries can be processed through a visual interface or an audible interface—sometimes via a telephonic connection. Each of U.S. Pat. No. 5,488,652 and U.S. Pat. No. 6,421,672 teach general purpose directory assistance systems.

Notably, to the extent that a directory assistance system provides post-lookup call processing including the automatic connection of the caller with a telephone number in a result set, oftentimes the only post-processing criteria for establishing the telephone connection is whether the caller agrees to be charged a nominal fee. More specifically, all telephone numbers in the result set can be treated equally in terms of access, regardless of the identity and nature of the selected telephone number. In many circumstances, however, it can be important to differentiate some telephone numbers from others prior to completing a call to a telephone number in a result set.

In contrast to directory assistance systems, the primary intent of a voice activated dialer system is to provide hands-free automatic dialing of telephone numbers. In the prototypical voice activated dialing system, a caller can specify the dialing of a telephone number by further specifying a directory query such as the name of the person or a department associated with the telephone number. If a matching telephone number can be located, the voice activated dialer system can automatically dial the matching phone number on behalf of the caller. In many cases the caller can be an outside caller dialing into the voice activated dialer system. In other cases, the caller can be a user of a device such as a cellular telephone which incorporates the voice activated dialer system. U.S. Pat. No. 6,236,715, U.S. Pat. No. 6,198,947 and U.S. Pat. No. 6,404,876 each teach rudimentary voice activated dialer systems.

The principal purpose of a directory assistance system is to provide directory information to requesting callers. In contrast, the principal purpose of a voice activated dialer systems is to connect requesting callers to parties associated with voice specified queries. Accordingly, the marketplace and resulting development track for directory assistance systems differs significantly from that of voice activated dialing. Specifically, directory assistance systems and voice activated dialing systems involve different record structures and program execution paths, each being more suited for the specific task associated with the respective system. Consequently, the utility and advantages unique to voice activated dialer systems heretofore have not been recognized in directory assistance systems. Conversely, the utility and advantages unique to directory assistance systems heretofore have not been recognized in voice activated dialer systems.

### SUMMARY OF THE INVENTION

The present invention addresses the deficiencies of the art in respect to directory assistance systems and methods and provides a novel and non-obvious call completion system, method and apparatus for integrated directory assistance and voice activated dialing based upon call transfer rules. In accordance with the present invention, a call completion system can include a set of call transfer rules implicating one of a directory assistance interface and a voice activated dialer interface. The system further can include a call completion processor configured to select one of a directory assistance interface and a voice activated dialer interface based upon an evaluation of the call transfer rules for an incoming query.

Preferably, the call transfer rules can include rules limiting the publication of information associated with a telephone endpoint. Additionally, the call transfer rules can include rules limiting the completion of a call to a telephone endpoint. In this regard, the call transfer rules can limit the publication of information associated with a private telephone endpoint. Furthermore, the call transfer rules can limit the completion of a call to an international telephone endpoint. Finally, the call transfer rules yet further can limit the completion of a call to an external telephone endpoint.

A call completion method can include processing a directory lookup query to locate a matching telephone endpoint and applying at least one call transfer rule to the matching telephone endpoint. Consequently, one of a directory assistance interface and a voice activated dialer interface can be selectively activated based upon the applied call transfer rule. In this regard, the activating step can include generating a prompt publishing telephone endpoint information for the matching telephone endpoint only if the applied at least one call transfer rule permits publication of the telephone endpoint information. Similarly, the activating step can include completing a call to the matching telephone endpoint only if the applied at least one call transfer rule permits call completion to the matching telephone endpoint.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an integrated call completion system which has been configured for operation utilizing call transfer rules; and,

FIG. 2 is a flow chart illustrating a method for processing directory assistance requests based upon call transfer rules in the system of FIG. 1.

### DETAILED DESCRIPTION OF THE PREFERRED EMBODIMENTS

The present invention is a method, system and apparatus for the integrated processing of directory assistance requests utilizing call transfer rules. In accordance with the present invention, a call completion system can selectively provide a directory assistance or voice activated dialing interface to calling parties depending upon call transfer rules. Specifically, incoming directory assistance requests can be processed for a caller to identify a result telephone end point. Call transfer rules further can be retrieved which can specify restrictions for completing a call to the end point and for reporting information to a caller regarding the endpoint. Subsequently, a call connection can be selectively established between the caller and the endpoint based upon the call transfer rules. Additionally, information regarding the result telephone end point can be selectively provided to the caller based upon the call transfer rules.

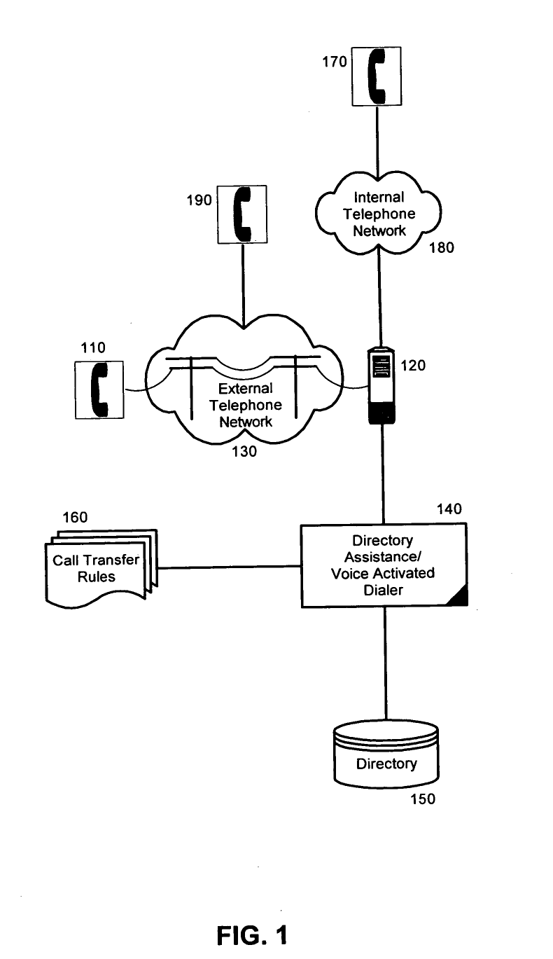

In more particular illustration, FIG. 1 is a schematic illustration of an integrated call completion system which has been configured for operation utilizing call transfer rules. The call completion system can include a telephony gateway 120 configured for coupling to one or more external callers 110 over an external telephone network. The telephony gateway 120 further can be configured for coupling to one or more telephone endpoints 170 over an internal telephone network 180. The telephony gateway 120 yet further can be configured for coupling to one or more telephone endpoints 190 over the external telephone network 130, whether a connection to the telephone endpoints 190 constitute a local or a long distance telephone call.

The telephony gateway 120 can include a call completion processor 140 having both a directory assistance interface and a voice activated dialer interface. The call completion processor 140 can be communicatively linked to a directory of telephone endpoints 150 which can include telephone number data keyed to identifying information corresponding to the telephone number data. The directory 150 further can include ancillary identifying information associated with the telephone number data. Finally, the call completion system can include a set of call transfer rules 160 linked to the call completion processor 140.

The call transfer rules 160 can apply to specific telephone endpoints, to groups of telephone endpoints, or globally to the entire call completion system. Notably, the call transfer rules 160 can limit the type of information regarding a telephone endpoint which can be provided to a caller. Non-limiting examples include whether a telephone number for a telephone endpoint 170 in the internal telephone network 180 can be provided to a requestor, such as whether a high level of privacy is required for the telephone endpoint. The call transfer rules 160 also can limit whether a call can be completed to a telephone endpoint. Further non-limiting examples include whether a call can be completed to an international telephone number or a telephone number for a telephone endpoint 190 which resides outside of the internal telephone network 130.

In operation, a caller 110 can establish a link to the telephony gateway 120 through which link the caller 110 can query the call completion processor 140. The query can include a request for directory information for a specified identity, such as a personal name, a department name, or a job title to name only a few. The call completion processor 140 can process the query to identify a telephone endpoint listed in the directory 150, such as a telephone number. Additionally, the call completion processor 140 can retrieve selected ones of the call transfer rules 160, whether the retrieved ones of the call transfer rules 160 are to be applied globally, or only to the specifically identified telephone endpoint.

Based upon the retrieved ones of the call transfer rules 160, the caller 110 can be presented with either a directory assistance or a voice activated dialer interface. Specifically, the caller 110 can be prompted with directory information for the telephone endpoint, or the caller 110 can be prompted with a notification that the requested information is not available due to the retrieved ones of the call transfer rules 160. Also, based upon the retrieved ones of the call transfer rules 160, the caller 110 can be prompted to complete the call to the requested telephone endpoint. Notwithstanding, if the retrieved ones of the call transfer rules 160 do not permit the completion of the call to the telephone end point, the caller 110 need not be prompted to complete the call to the requested telephone endpoint.

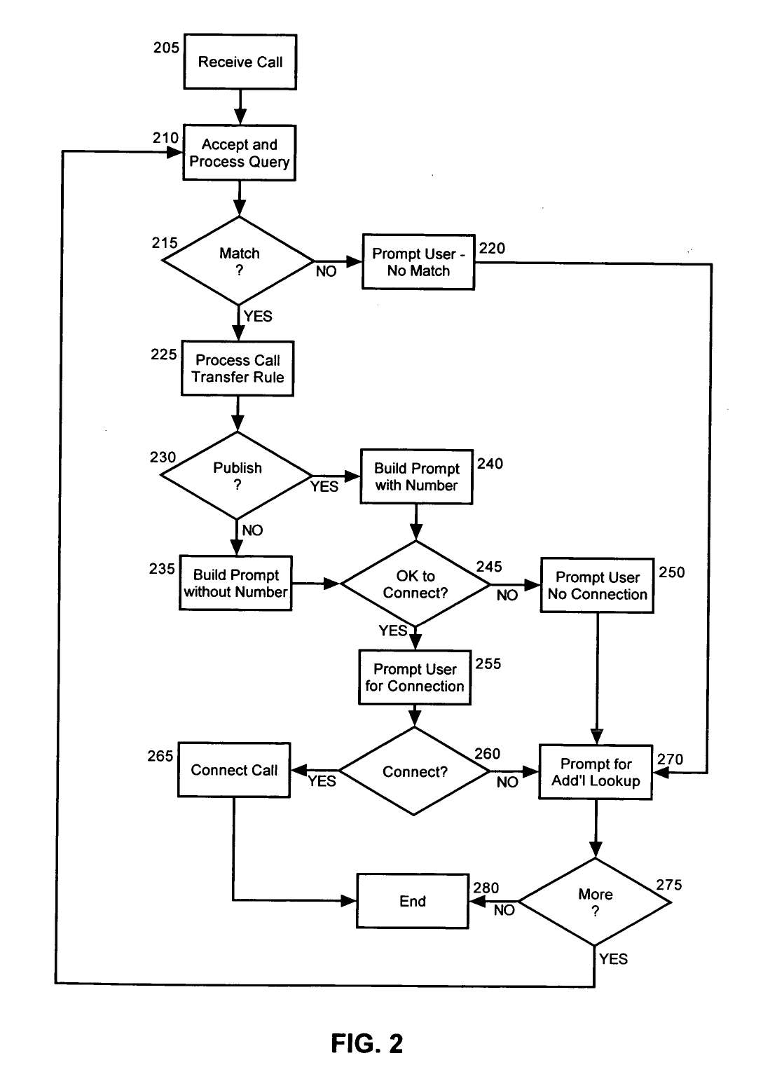

In more particular illustration of the process of the invention, FIG. 2 is a flow chart illustrating a method for processing directory assistance requests based upon call transfer rules in the system of FIG. 1. Beginning in block 205, a query for directory information can be received. The query can be received telephonically from an external or internal telephone caller, or computationally through an external or internal data communications network. Moreover, the query can be audibly provided, or computationally provided, depending upon the interface utilized by the caller to submit the query.

In any case, in block 210 the query can be processed by performing a lookup operation on one or more directories to locate a telephone endpoint for the query. If in decision block 215 a match cannot be located for the query, in block 220 a prompt can be generated indicating a no match condition. Otherwise, in block 225 the call transfer rules for the matching telephone endpoint (including global call transfer rules) can be processed to determine, for instance, limitations upon the publication of telephone endpoint information and the completion of a call to the telephone endpoint. In decision block 230, if the call transfer rules permit publication of telephone endpoint information for the telephone endpoint, in block 240 a prompt can be constructed which specifies the telephone endpoint information. Otherwise, in block 235 a prompt can be constructed which indicates the unavailability of the telephone endpoint information.

In either case, in decision block 245 it can be determined whether the call transfer rules permit the completion of a call to the telephone endpoint. If not, in block 250 a prompt can be constructed indicating that no connection is available and in block 270 an additional prompt can be constructed prompting for an additional lookup operation. If it is determined in decision block 275 that no further lookup operations are to be conducted, the process can end in block 280. In contrast, if it is determined in decision block 275 that additional lookup operations are desired, the process can repeat beginning in block 210.

Returning now to decision block 245, if it is determined that the call transfer rules permit the completion of a call to the telephone endpoint, in block 255 a prompt can be constructed to determine whether call completion to the telephone endpoint is desired. In decision block 260 if it is determined that call completion is desired, in block 265 a call can be completed to the telephone endpoint and the process can end in block 280. Otherwise, in block 270 an additional prompt can be constructed prompting for an additional lookup operation. If it is determined in decision block 275 that no further lookup operations are to be conducted, the process can end in block 280. In contrast, if it is determined in decision block 275 that additional lookup operations are desired, the process can repeat beginning in block 210.

In accordance with the present invention, a call completion processor can integrate the characteristics of a directory assistance system with those of a voice activated dialer. Importantly, the call completion processor can selectively provide a directory assistance like interface and a voice activated dialer like interface depending upon the evaluation of call transfer rules which can limit the completion of a call to a telephone endpoint, or the publication of information regarding the telephone endpoint. These call transfer rules can be either global in scope, or granular in scope in order to provide flexibility to the call completion system of the present invention.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A call completion system comprising:
a set of call transfer rules implicating one of a directory assistance interface and a voice activated dialer interface; and,
a call completion processor configured to select one of a directory assistance interface and a voice activated dialer interface based upon an evaluation of said call transfer rules for an incoming query.

2. The system of claim 1, wherein said call transfer rules comprise rules limiting the publication of information associated with a telephone endpoint.

3. The system of claim 1, wherein said call transfer rules comprise rules limiting the completion of a call to a telephone endpoint.

4. The system of claim 2, wherein said call transfer rules limit the publication of information associated with a private telephone endpoint.

5. The system of claim 3, wherein said call transfer rules limit the completion of a call to an international telephone endpoint.

6. The system of claim 3, wherein said call transfer rules limit the completion of a call to an external telephone endpoint.

7. The system of claim 1, wherein said incoming query is a voice query provided telephonically through a telephony gateway.

8. The system of claim 1, wherein said incoming query is a data query provided computationally through a data communications network.

9. The system of claim 1, wherein said incoming query is a voice query provided audibly through a data communications network.

10. A call completion method comprising the steps of:
processing a directory lookup query to locate a matching telephone endpoint;
applying at least one call transfer rule to said matching telephone endpoint; and,
selectively activating one of a directory assistance interface and a voice activated dialer interface based upon said applied at least one call transfer rule.

11. The method of claim 10, wherein said activating step comprises the step of generating a prompt publishing telephone endpoint information for said matching telephone endpoint only if said applied at least one call transfer rule permits publication of said telephone endpoint information.

12. The method of claim 10, wherein said activating step comprises the step of completing a call to said matching telephone endpoint only if said applied at least one call transfer rule permits call completion to said matching telephone endpoint.

13. The method of claim 10, further comprising the step of specifying a call transfer rule to prohibit the completion of calls to an international telephone endpoint.

14. The method of claim 10, further comprising the step of specifying a call transfer rule to prohibit the completion of calls to an external telephone endpoint.

15. The method of claim 10, further comprising the step of specifying a call transfer rule to prohibit the publication of telephone endpoint information for a specific telephone endpoint.

16. A machine readable storage having stored thereon a computer program for call completion, the computer program comprising a routine set of instructions which when executed by a machine causes the machine to perform the steps of:
processing a directory lookup query to locate a matching telephone endpoint;
applying at least one call transfer rule to said matching telephone endpoint; and,
selectively activating one of a directory assistance interface and a voice activated dialer interface based upon said applied at least one call transfer rule.

17. The machine readable storage of claim 16, wherein said activating step comprises the step of generating a prompt publishing telephone endpoint information for said matching telephone endpoint only if said applied at least one call transfer rule permits publication of said telephone endpoint information.

18. The machine readable storage of claim 16, wherein said activating step comprises the step of completing a call to said matching telephone endpoint only if said applied at least one call transfer rule permits call completion to said matching telephone endpoint.

19. The machine readable storage of claim 16, further comprising the step of specifying a call transfer rule to prohibit the completion of calls to an international telephone endpoint.

20. The machine readable storage of claim 16, further comprising the step of specifying a call transfer rule to prohibit the completion of calls to an external telephone endpoint.

21. The machine readable storage of claim 16, further comprising the step of specifying a call transfer rule to prohibit the publication of telephone endpoint information for a specific telephone endpoint.
